(19) United States
(12) Patent Application Publication
(10) Pub. No.: US 2002/0006809 A1
(43) Pub. Date: Jan. 17, 2002

(54) Portable radio terminal device

(76) Inventors: Tetsuya Kubo, Yokohama-shi (JP); Masao Kobayashi, Yokohama-shi (JP); Suguru Suzuki, Yokohama-shi (JP); Teruo Nanmoku, Naka-gun (JP); Hidehiro Yanagibashi, Kawasaki-shi (JP)

Correspondence Address: PEARNE & GORDON LLP, 526 SUPERIOR AVENUE EAST, SUITE 1200, CLEVELAND, OH, 44114-1484, US

(21) Appl. No.: 09/904,988

(22) Filed: Jul. 13, 2001

(30) Foreign Application Priority Data
Jul. 14, 2000 (JP) 2000-214586
Jul. 14, 2000 (JP) 2000-214664
Jul. 14, 2000 (JP) 2000-214665
Jul. 14, 2000 (JP) 2000-214666
Aug. 4, 2000 (JP) 2000-236983

(51) Int. Cl. H04M 1/00

(52) U.S. Cl. 455/550; 455/90

(57) ABSTRACT

A portable radio device (100) has the lower casing (120) and the upper casing (110), and a hinge portion (130) to connect together the lower and upper casings (120) and (110) respectively roatatably, and is provided with a convex portion for accommodating a microphone (128) which is provided on the surface A of the inside of the lower casing (20) and protruded from the surface A of the inside, and a concave portion for accommodating a receiver (116) which is provided at a position opposite to the convex portion (128) when the lower and upper casings (120) and (110) are folded on the surface B of the inside of the upper casing (110), and is formed so that the convex portion (128) can be fitted.

### BACKGROUND OF THE INVENTION

The present invention relates to a portable radio device. Particularly, the invention relates to a technology to reduce the thickness of a casing of the folding portable radio device. Further, the present invention relates to a portable radio device with an antenna, such as a portable telephone device. Moreover, the invention relates to the portable radio device whose antenna is accommodated in the lower casing. Further, the invention relates to a folding portable telephone device in which a lower casing and a upper casing can be respectively rotated.

Recently, in order to enhance the improvement of the size and weight reduction and the portability, various portable radio devices are developed. Among them, a folding portable radio device structured so that the casing of the portable radio device is divided and is foldable, has an excellent shape in which its accommodation into a pocket or bag can be easily conducted while securing the operability at the time of transmission and reception.

The portable radio device is structured in such a manner that a circuit board including a radio circuit on which electronic parts such as a CPU to process each kind of signals, or a memory to store each kind of information, are mounted, is accommodated in the casing, and supported by a support plate integrally formed with the casing.

In the conventional folding portable radio device, in the case of a folding portable radio device including a lower casing in which a primary circuit board is accommodated, and a upper casing which is insulated from the lower casing and combined so that it can be opened and closed, the antenna is provided in the upper casing.

In this connection, when the arrangement position is on the upper casing side, there is a disadvantage that the wiring from the antenna to the lower casing in which the primary circuit board is accommodated, through the hinge portion, is long, and the device becomes complicated, and the power loss is increased, accordingly, the antenna gain is lowered and the sensibility of the radio device is lowered.

Further, when the antenna is on the upper casing side, the weight of the upper casing is increased, and the stability in the condition that the upper casing is opened is poor.

Accordingly, as a portable radio device to solve the above disadvantage, the antenna is provided in the lower casing side in which the primary circuit board is accommodated. According to such the structure, the wiring becomes short and the antenna gain is not lowered, accordingly, the sensibility of the radio device is not lowered. Further, the trouble of the hinge portion is reduced.

Referring to FIG. 16 and FIG. 17, the structure of the antenna lower casing accommodation type portable radio device, which is an object of the present invention, will be described below.

In FIG. 16 and FIG. 17, numeral 10 is a portable telephone device provided with a speaker of a receiver unit and a microphone of a transmitter unit, and this portable telephone device 10 includes a lower casing 30 and upper casing 20, and hinge portion 40 combining these casings respectively rotatably.

In the lower casing 20, a microphone 22 which is a transmitter unit to input the voice emitted from the user of a portable telephone device 10, a switch for a power source on/off of the portable telephone device 10, and operation key 24 including numeric keys for alphanumeric characters input, and function keys for selecting and conducting each kind of functions, are provided. An antenna accommodation section 21 is provided on one side surface of the lower casing 20, and almost all portions of an antenna 50 is accommodated therein. Further, as shown by a sectional view in FIG. 17, in the inside of the lower casing 20, a primary circuit board 26 on which electronic parts 28 such as a CPU to process each kind of signals, or a memory to store each kind of information are mounted, is provided, and the primary circuit board 26 is supported and fixed in the lower casing 20 by a supporter 29. Further, a feeder 52 of the antenna 50 is connected to a circuit pattern of the primary circuit board 26, and an electrical ground line 54 of the antenna 50 is connected to an antenna ground plate 27. Then, the antenna ground plate 27 is electrically connected to the lower casing 20 by the supporter 29. Further, in a battery pack accommodation unit 70′ of the lower casing 20, a comparatively weighty unit such as a battery pack 80′ is accommodated, and the center of gravity of the weight of the portable telephone device 10 exists on the lower casing 20 side. Accordingly, when the portable telephone device 10 is used, the portable telephone device 10 is more stable when the user holds the lower casing 20 by a hand, and the undesirable force does not exert onto the hinge portion 40, which is preferable.

In the upper casing 30, a speaker 32 which is a receiver unit for the user of the portable telephone device 10 to listen, display portion 34 of the portable telephone device 10, and secondary circuit board 36 to which these speaker 32 and the display portion 34 are connected, are accommodated. Further, the electric ground pattern on the secondary circuit board 36 is electrically insulated from the upper casing 30, and the secondary circuit board 36 is connected to the primary circuit board 26 by a flexible board (not shown) connected to respective boards through the inside of the hinge portion 40, and each kind of electric signals are sent and received between respective boards.

The hinge portion 40 rotatably combines the lower casing 20 and upper casing 30 with each other, and when the portable telephone device 10 is used, these casings are opened by a predetermined angle, for example, a slightly smaller angle than 180°, and used. It is better that the angle is set so that, when the microphone 22 is placed near the mouth, the speaker 32 is just located near the ear.

Further, the hinge portion 40 electrically insulates the lower casing 20 and the upper casing 30 from each other, and accordingly, the upper casing 30 is electrically insulated from the lower casing 20.

The antenna 50 is a whip antennas which can be extended and accommodated, and when the antenna is accommodated, a tip portion of the antenna 50 is left, and the antenna 50 is accommodated in the antenna accommodation portion 21 (FIG. 2). Further, when the portable telephone device 10 is used, the antenna 50 is pulled out to the cover rear surface 31 side reversed to the surface opposite to the human body of the casing 30. Then, when the antenna 50 is extended, as shown in FIG. 17, between the antenna 50 and the cover rear surface 31 of the upper casing 30, an angle of a predetermined angle θ1 is formed.

According to the structure as described above, in the portable radio device as the object of the present invention, because the antenna 50 is placed on the lower casing 20 side in which the primary circuit board is accommodated, the antenna gain is not lowered, and the sensibility of the radio device is not lowered.

In the above folding portable radio device, because the casing is folded, the thickness of the device becomes almost 2 times in the folded condition, therefore, the more reduction of the thickness of the casing is required.

In this connection, in the casing of this folding portable radio device, essential parts such as, for example, a microphone, receiver, and each kind of button switch, or display panel, are mounted in a high density, and because of the size reduction, the mounting area is narrow, and it is structured in such a manner that each of parts is concentrically laminated. Accordingly, the thickness of the casing is reduced almost to the limit, and it is in a condition in which the more reduction of the thickness is difficult.

Accordingly, when the arrangement layout of parts is changed, or a part having comparatively large thickness is used, it is necessary to cope with the case by increasing the thickness of the device.

Further, in this connection, in the case of the portable telephone device which is used in such a manner that the upper casing is opened and closed, the portable telephone device is often placed on the plane such as the desk in the condition that the upper casing remains opened.

In the conventional portable telephone device, in this case, a portion which is brought into contact with the plane is only the bottom surface portion of the lower casing. Accordingly, when the portable telephone device is placed in such a condition that the upper casing remains opened, the stability becomes poor and the telephone device is easily tilted to the upper casing side because the telephone device with the lower casing being opened is supported by only the bottom surface portion of the lower casing.

FIG. 18 is a view for explaining this condition, and generally shows the condition in which the conventional portable telephone device is placed on a plane such as a desk in the condition that the cover remains opened. In the drawing, the portable telephone device 10 is in the condition in which the upper casing 30 is opened maximum from the lower casing 20 around the hinge portion 40 as the rotation center, however, in this case, the rear surface 30″ of the upper casing 30 is in a floated condition from the horizontal surface T of the desk. A portion which supports the portable telephone device 10, is only the bottom portion of the lower casing 20. Accordingly, in this condition, because the area in which the portable telephone device 10 is in contact with the desk, is small, the stability becomes poor, and the portable telephone device 10 is easily tilted.

Further, when the portable telephone device is placed in such the condition that the upper casing 30 remains opened, the weight of the upper casing is applied onto the hinge portion 40 as it is, thereby, the hinge portion 40 is easily broken. Furthermore, in the conventional the portable telephone device which has the large weight in the upper casing itself in such a manner that the antenna is accommodated in the upper casing side, this tendency is larger.

Moreover, in this connection, in the case of the portable radio device in which the antenna is accommodated in the lower casing side, a portion which is grasped by a hand is a portion of the lower casing. In this case, as shown in FIG. 9B, there is a possibility that the hinge portion which has the largest constriction is grasped by a thumb and the first finger. In such the case, the first finger contacts with the antenna willy-nilly, and when the finger touches the antenna, the antenna gain is lowered, and the sensibility of the radio device is lowered.

Furthermore, in this connection, in the case of the portable radio device 10 in which the antenna 50 is accommodated in the lower casing 20 side in this manner, the battery pack 80′ is originally accommodated in the lower casing 20 side, and as can be seen from FIG. 17, because the battery pack 80′ is accommodated fully in the width direction from one side surface portion in the width direction of the lower casing 20 to the other side surface portion, the antenna 50 is arranged in the weight in the thickness direction in the lower casing 20.

Accordingly, the thickness of the lower casing 20 is increased and it is inevitable to go against the needs of the times of the thickness reduction of the potable radio device 10.

Further, In order to improve the size and weight reduction and the portability, in the casing of the portable radio device, the circuit board including the radio circuit, and inevitable parts such as a microphone, and each kind of button switches are mounted in the high density. Further, when the antenna is accommodated so that it can be extended and contracted in the side in the casing, in order to attach a guide member of the antenna in the casing, an area of the support plate to support the circuit board is inevitably decreased, and as a result, the mounting area of the circuit board is inevitably reduced. Accordingly, it is difficult to provide a predetermined function and a new function to the portable radio device.

Further, when, on the side in the casing whose thickness is extremely reduced in order to reduce the size and the weight, the accommodation portion to accommodate the antenna is tried to be provided, the strength of the casing is reduced, and particularly, in the case of folding portable radio device, it is difficult to secure the strength of the casing which can endure many times of the open and close.

Further, when the antenna is tried to be provided near the circuit board including the radio circuit on which electronic parts such as the CPU to process each kind of signals or the memory to store each kind of information is mounted, by the influence of noise of each kind of circuits on the circuit board, the possibility that the characteristic of the antenna is lowered, is generated.

### SUMMARY OF THE INVENTION

In view of such the situation, the present invention is attained, and the object of the present invention is to provide a folding portable radio device, in which, when the thick accommodation space is locally necessary, without increasing the thickness of the device, the thickness of the device can be reduced when the casing is folded.

Further, the present invention is attained in view of the such the condition, and the object of the present invention is to provide a portable telephone device in which, even when the portable telephone device is placed in the condition in which the upper casing remains opened, its stability is good and it is hardly tilted, and further, the hinge portion is hardly troubled.

Moreover, in view of such the condition, the present invention is attained, and the object of the invention is to provide a portable radio device in which, when the lower casing has the shape in which the first finger hardly touches the antenna, the first finger does not touch the antenna, accordingly, the antenna gain can be sufficiently obtained.

Furthermore, the present invention solves this problem, and the object of the present invention is to provide the potable radio device in which the antenna 50 is accommodated in the lower casing 20 side so that the antenna gain is not lowered, and the thickness reduction of the potable radio device 10 can be attained.

Further, in view of the above conditions, the present invention is attained, and the object of the present invention is to provide the portable radio device in which a predetermined mounting area in the circuit board and the predetermined strength of the casing can be secured, and the noise of each kind of circuits on the circuit board does not affect the antenna.

In order to attain the above object, according to the first aspect of the invention, a portable radio device comprises:

a first casing;

a second casing;

a hinge portion to connect together the first and second casings respectively roatatably;

a convex portion provided on the inside surface of the first casing and protruded from the surface of the inside; and

a concave portion provided on the inside surface of the second casing,

wherein the convex portion and the concave portion are fitted when the first and second casings are folded.

In this portable radio device, when the first casing and the second casing are folded, the convex portion protruded from the surface of the inside of the first casing is fitted in the concave portion which is provided opposite to the convex portion and formed on the surface of the inside of the second casing. Thereby, even when a sufficient accommodation space of the part cannot be obtained in the first casing, the part can be accommodated by using an additional space in the first casing formed by the protruded portion, and to the other portions except for the convex portion requiring the thickness, the thickness of the first casing can be maintained in the reduced condition. Further, when the concave portion is formed in the second casing opposite to the convex portion of the first casing, the increase of the thickness of the portable radio device when each of casings is folded, can be prevented. Accordingly, when the thick accommodation space is locally necessary, without increasing the thickness of the whole device, the thickness of the device when the casings are folded can be reduced.

Preferably, according to the second aspect of the invention, the portable radio device as set forth in the first aspect, a telephone transmitter unit to detect sounds is accommodated in a space in the first casing formed by the convex portion.

In this portable radio device, when the telephone transmitter unit to detect sounds is accommodated in the space of the first casing formed by the convex portion, the accommodation space of the telephone transmitter unit in which the thickness is locally required due to the interference with the other parts can be obtained by the locally formed convex portion without increasing the thickness of the whole device, and the thickness in the condition in which the portable radio device is folded, can be reduced. Further, when the telephone transmitter unit is protruded from the surface of the first casing, the sound collection property of sounds can be increased.

Further, according to the third aspect of the invention, the portable radio device as set forth in the second aspect, a receiver unit to emit sounds is accommodated in a position of the concave portion.

In this folding portable radio device, when the receiver unit to emit sounds is accommodated in the position of the concave portion, because there is no protruded portion from the surface of the second casing, the hearing feeling becomes good, and when the sound from the receiver unit is echoed by the concave portion, the sound can be easily heard.

Furthermore, according to the fourth aspect of the invention, a portable radio device comprises:

a first casing in which a primary circuit board is accommodated;

a second casing; and

a hinge portion to connect together the first and second casings respectively roatatably;

wherein, when the device is placed on the plane in the condition in which the second casing is opened from the first casing, a bottom surface of the first casing and a contact portion of the second casing are brought into contact with the plane.

According to the structure as described above, other than the bottom surface of the lower casing, because a portion of the upper casing is brought into contact with the plane, even when the portable telephone device is placed in the condition in which the upper casing remains opened, the stability is good and the portable telephone device is not tilted.

Furthermore, according to the fifth aspect of the invention, the portable radio device as set forth in the fourth aspect, the contact portion is provided on the second casing near the hinge portion.

According to the structure as described above, because the weight of the upper casing is supported by the vicinity of the hinge portion, so much burden is not applied onto the hinge portion.

Moreover, according to the sixth aspect of the invention, the portable radio device as set fourth in the fourth aspect, the contact portion is formed into a convex portion.

According to the structure as described above, even when the design accuracy of the curved surface of the upper casing rear surface is not increased so much high, there is no fluctuation, and the stability is good.

Furthermore, according to the seventh aspect of the invention, the portable radio device as set forth in the sixth aspect, the convex portion is formed on a center line in the longitudinal direction of the second casing.

Moreover, according to the eighth aspect of the invention, the portable radio device as set forth in the sixth aspect, the convex portion is formed on a line at a right angle with the center line of the second casing.

According to the structure as described above, the balance of the left and right is good for the center line in the longitudinal direction of the upper casing, and the stability becomes good.

Further, according to ninth aspect of the invention, a portable radio device comprises:

a first casing in which a primary circuit board is accommodated;

a second casing; and

a hinge portion to connect together the first and second casings respectively roatatably;

wherein, when the device is placed on the plane in the condition in which the second casing is opened from the first casing, a lower side portion of bottom surface of the first casing and a contact portion of the second casing are brought into contact with the plane.

According to the structure as described above, because only an opposite side bottom portion of the hinge portion of the bottom surface of the lower casing and a portion of the upper casing are brought into contact with the plane, even when there is some design error or uneven portion on the bottom surface of the lower casing, the stability is good in no relationship to this and the device is not tilted.

Furthermore, according to the tenth aspect of the invention, the portable radio device as set forth in the ninth aspect, the contact portion is provided on the second casing near the hinge portion.

According to the structure as described above, because the weight of the upper casing is supported by the vicinity of the hinge portion, so much burden is not applied onto the hinge portion.

Moreover, according to the eleventh aspect of the invention, the portable radio device as set fourth in the ninth aspect, the contact portion is formed into a convex portion.

According to the structure as described above, even when the design accuracy of the curved surface of the upper casing rear surface is not increased so much high, there is no fluctuation, and the stability is good.

Furthermore, according to the twelfth aspect of the invention, the portable radio device as set forth in the eleventh aspect, the convex portion is formed on a center line in the longitudinal direction of the second casing.

Moreover, according to the thirteenth aspect of the invention, the portable radio device as set forth in the eleventh aspect, the convex portion is formed on a line at a right angle with the center line of the second casing.

According to the structure as described above, the balance of the left and right is good for the center line in the longitudinal direction of the upper casing, and the stability becomes good.

Furthermore, according to the fourteenth aspect of the invention, a portable radio device comprises:

a first casing in which an antenna and a primary circuit board are accommodated;

a second casing;

a hinge portion to connect together the first and second casings respectively roatatably; and

a first concave portion for putting a finger formed on an antenna accommodation portion to accommodate the antenna of the first casing.

According to the structure as described above, when the portable radio device is held by a hand, because the fingers are put on the finger put concave portion unconsciously, the finger can be prevented from touching the antenna, accordingly, the antenna gain is not lowered.

Further, in the case where the a portable radio device is held by a hand when the telephone call is made, because the fingers are in contact with the concave portion, even when the portable radio device is not so firmly gripped, it hardly drops from the fingers, thereby, the grip property is also increased.

Preferably, according to the fifteenth aspect of the invention, the portable radio device as set forth in fourteenth aspect, the curvature of concave portion is the curvature of the cross sectional shape of the finger and over.

According to the structure as described above, the fingers can be easily put on the finger put concave portion of the portable radio device, thereby, the finger is prevented from touching the antenna, accordingly, the antenna gain is not lowered. Further, the grip property is increased.

Further, according to the sixteenth aspect of the invention, the portable radio device as set forth in the fourteenth aspect, further comprises a second concave portion formed on a portion of the opposite side of the first casing of the antenna accommodation portion.

According to the structure as described above, because the human has the habit to grasp a portion on which it is considered to be narrowest, and because a concave portion is formed also on the reverse side, a portion formed between this portion and the finger put concave portion on the antenna side is sensed to be narrow, and the portion between them is gripped unconsciously, accordingly, the finger put concave portion on the antenna side is more surely used.

Further, the grip property is more increased.

Moreover, according to seventh aspect of the invention, a portable radio device comprises:

a first casing in which an antenna and a primary circuit board are accommodated;

a second casing;

a hinge portion to connect together the first and second casings respectively roatatably;

an antenna accommodation portion to accommodate the antenna provided along one side surface of the first casing; and

a battery pack accommodation unit provided between the other side surface of the first casing and the antenna accommodation portion.

According to the structure described above, the antenna and the battery pack are not overlapped vertically on each other, and because the antenna and the battery pack are arranged in parallel with each other, the low-profile portable radio device can be obtained.

Preferably, according to the eighteenth aspect of the invention, the portable radio device as set forth in seventeenth aspect, further comprises a rib provided along the antenna accommodation portion in the battery pack accommodation unit.

Because the antenna is accommodated in the lower casing side, although it is required that the strength of the lower casing is increased, by the above structure, the rigidity of the lower casing can be secured.

Further, according to ninth aspect of the invention, a portable radio device comprises:

an antenna portion on the side of a casing;

a circuit board provided in the casing;

a first shield unit provided in the casing; and

a second shield unit provided between the antenna portion and the circuit board,

wherein the first shield unit and the second shield unit shields the electrical noise from the circuit board portion.

According to such the structure, it can be prominently prevented that the bad influence from the circuit board affects the antenna.

Preferably, according to the twentieth aspect of the invention, the portable radio device as set forth in the ninth aspect, the metallic evaporation is conducted on at least one of the first shield portion and the second shield portion.

According to such the structure, it can be prominently prevented that the bad influence from the circuit board affects the antenna.

Further, according to twenty-first aspect of the invention, a portable radio device comprises:

an antenna provided on a side of a casing;

an antenna accommodation portion to accommodate the antenna;

a circuit board provided in a casing;

a support plate for supporting the circuit board; and

an auxiliary support plate mounted in the casing so that the support plate is extended to the vicinity of the antenna accommodation portion, the auxiliary support plate partitions a space in which the antenna is accommodated, together with a side portion of the inner surface of the casing, and the circuit board and the antenna are shielded.

According to such the structure, when the structured that, for example, after a guide member of the antenna is attached into the casing, the auxiliary support plate is mounted in the casing, is applied, the support plate can be extended to the vicinity of the antenna accommodation portion. Accordingly, the mounting area of the circuit board can be increased. Further, by this auxiliary support plate, the strength of the casing provided with the antenna accommodation portion can be increased and it can be prevented that the bad influence from the circuit board affects the antenna.

Preferably, according to twenty-second aspect of the invention, the portable radio device as set forth in twenty-first aspect, the metallic evaporation is conducted on at least one of the support plate and the auxiliary support plate.

According to such the structure, it can be prominently prevented that the bad influence from the circuit board affects the antenna.

Further, according to the twenty-third aspect of the invention, a folding portable radio device comprises:

a first casing;

a second casing;

a hinge portion to connect together the first and second casings respectively roatatably;

an antenna accommodation portion provided in a side of the first casing to accommodate an antenna;

a circuit board provided in the first casing;

a support plate for supporting the circuit board; and

an auxiliary support plate mounted in the first casing so that the support plate is extended to the vicinity of the antenna accommodation portion, the auxiliary support plate partitions a space in which the antenna is accommodated, together with a side portion of the inner surface of the first casing, and the circuit board and the antenna are shielded.

According to such the structure, even when the antenna is provided in one casing in which the circuit board including the radio circuit in which, for example, the CPU or memory is mounted, is accommodated, the expansion of the mounting area of the circuit board is possible, and further, by the auxiliary support plate, the strength of the casing can be increased, and it can be prevented that the bad influence from the circuit board affects the antenna.

Preferably, according to twenty-fourth aspect of the invention, the portable radio device according to twenty-third aspect, the metallic evaporation is conducted on at least one of the support plate and the auxiliary support plate.

According to such the structure, it can be prominently prevented that the bad influence from the circuit board affects the antenna.

### BRIEF DESCRIPTION OF THE DRAWINGS

FIG. 1 is a view of the whole appearance of a folding portable telephone device according to the first embodiment, and FIG. 1A is a front view and FIG. 1B is a side view;

FIG. 2 is a perspective view of the appearance showing a folded condition of the folding portable telephone device according to the first embodiment;

FIG. 3 is a view showing an accommodation condition of a telephone transmitter unit according to the first embodiment;

FIG. 4 is a view showing accommodation portions of a receiver unit and the telephone transmitter unit according to the first embodiment, and FIG. 4A is a microphone accommodation portion of a lower casing, and FIG. 4B is a receiver accommodation portion of an upper casing;

FIG. 5 is a view shown by using a partial section showing a condition in which a protruded portion of the microphone accommodation portion of the portable telephone device is fitted in a concave portion of the receiver accommodation portion according to the first embodiment, and FIG. 5A shows the condition in which the upper casing and the lower casing are opened, and FIG. 5B shows the condition in which each casing is folded;

FIG. 6A is a side view of the portable telephone device according to the second embodiment of the present invention, and FIG. 6B is a front view;

FIG. 7 is a view generally showing a condition in which the portable telephone device is placed on the desk while it is opened according to the second embodiment, and FIG. 7A is a case in which a portion of the bottom portion of the lower casing 220 and the convex portion 230A of the upper casing rear surface are used, and FIG. 7B is a case in which the whole bottom portion of the lower casing 220 and the convex portion 230A of the upper casing rear surface are used.

FIG. 8A is a side view of the whole portable telephone device according to the third embodiment of the present invention, and FIG. 8B is its front view;

FIG. 9 is views typically showing the grip conditions of a portable telephone device, and FIG. 9A is a view of the grip condition of the portable telephone device according to the third embodiment of present invention and FIG. 9B is a view of the grip condition of the conventional portable telephone device;

FIG. 10 is a front view of a portable telephone device according to another example of the third embodiment;

FIG. 11 is a view showing the condition that a upper casing of a potable telephone device is closed being overlapped on a lower casing according to the fourth embodiment, and FIG. 11A is a side view of the lower casing in which a battery pack is housed, and FIG. 11B is a plan view in which FIG. 11A is viewed from the bottom surface side, FIG. 11C is a plan view in which the lower casing from which the battery pack is removed, is viewed from the bottom surface side, and FIG. 11D is a front view of FIG. 11B;

FIG. 12 is a view of the whole appearance of a folding portable telephone device according to the fifth embodiment, and FIG. 12A is a front view, and FIG. 12B is a side view;

FIG. 13 is a perspective view showing a primary circuit board and secondary circuit board according to the fifth embodiment;

FIG. 14 is an inner surface side perspective view of a rear case of a lower casing according to the fifth embodiment;

FIG. 15 is an outer surface side perspective view of the rear case of the lower casing according to the fifth embodiment;

FIG. 16 is a perspective view of the conventional folding portable radio device;

FIG. 17 is a sectional view typically showing the structure of the conventional folding portable radio device; and

FIG. 18 is a view generally showing a condition in which the conventional folding portable telephone device is placed on the desk while it is opened.

### DETAILED DESCRIPTION OF THE PREFERRED EMBODIMENT

(Embodiment 1)

Referring to the drawings, the first embodiment of the folding portable radio device according to the present invention will be detailed below. In the first embodiment, as a specific example of the folding portable radio device, a folding portable telephone device will be detailed.

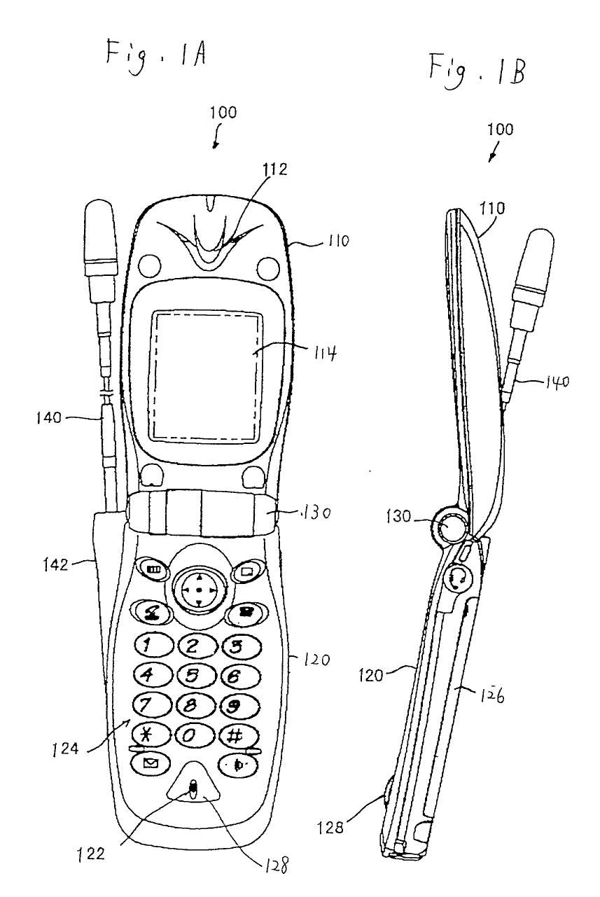

Herein, FIG. 1 is a view of the whole appearance of a folding portable telephone device, and FIG. 1A is a front view and FIG. 1B is a side view, and FIG. 2 is a perspective view of the appearance showing a folded situation of the folding portable telephone device.

Initially, the structure of a folding portable telephone device 100 of the present embodiment will be described below. As shown in FIG. 1, in the folding portable telephone device 100 of the present embodiment, the casing is divided into an upper casing (the second casing) 110 and a lower casing (the first casing) 120, and these upper casing 110 and the lower casing 120 are connected to be respectively rotatable by a hinge portion 130. When the upper casing 110 of this folding portable telephone device 100 is rotated around the hinge portion 130, the portable telephone device 100 can be folded up to a position at which the upper casing 110 is brought into contact with the lower casing 120, or approximately contact with the lower casing 120, and as the result, it can be in the folded situation as shown in FIG. 2.

In the upper casing 110 of this folding portable telephone device 100, the receiver unit having a receiver (speaker) 112 to emit the sound such as the voice, and an information display portion 114 such as a liquid crystal display panel are provided, and in the lower casing 120, the telephone transmitter unit having a microphone 122 to detect the sound such as the voice, key operation section 124, and buttery 126 are provided.

Further, on one side surface (left side in FIG. 1A) of the lower casing 120, an antenna accommodation portion 142 in which an antenna 140 is accommodated, is arranged almost in parallel with the longitudinal direction of the lower casing 120. This antenna 140 is, for example, a whip antenna, and is extensible and provided in the lower casing 120. That is, the antenna 140 is extended by pulling out in the direction of the upper casing 110 when it is extended, as shown in FIG. 1, and is faced to the direction away from the human body when the telephone is in use, and on the one hand, when it is accommodated, as shown in FIG. 2, a tip portion 140a is remained, and other portion of the antenna 140 is accommodated in the antenna accommodation portion 142.

In the key operation section 124 of the lower casing 140, a switch for the power on/off of the portable telephone device 100, keys for alphanumeric characters and character input, and function keys to select and conduct each kind of functions, are included.

On the rear surface of the key operation section 124, the battery 126 having comparatively large weight, is detachably fitted, and when the position of the gravity center of the portable telephone device 100 is positioned in the lower casing 120, the holding stability is obtained.

Further, in the inner portion of the lower casing 120, a primary circuit board (not shown) including a radio circuit in which electronic parts such as a CPU to execute the process of each kind of signals, or a memory to store each kind of information, are mounted, a microphone 122 of the telephone transmitter unit, and a panel switch of the key operation section 124, are accommodated. These parts are fixed in the inner portion of the lower casing 120 by a supporting body integrally formed with the lower casing 120, and, in this connection, the battery 126 is fitted being overlapped with the attached position of the microphone 122 in the thickness direction.

Further, in the inner portion of the upper casing 110, a secondary circuit board (not shown) including a driver circuit of the information display portion 114, and a speaker 112 of the receiver unit, are accommodated, and in the same manner, fixed in the upper casing 110 by the supporting body. The above primary circuit board and the secondary circuit board are connected with each other through a flexible board (not shown), and sending and receiving of each kind of electric signal are conducted between respective circuit boards. In this connection, the flexible board combines the circuit boards with each other through the inner portion of the hinge portion 130.

Herein, in the above portable telephone device 100, because the antenna 140 is arranged on the lower casing 120, it has the advantage in which the connection distance with the radio circuit accommodated in the lower casing is short enough, power consumption can be suppressed, and the reception sensibility can be increased.

Next, in the folding portable telephone device 100 structured as described above, the fitting structure of the telephone transmitter unit and receiver unit onto each of casings 110 and 120, will be detailed.

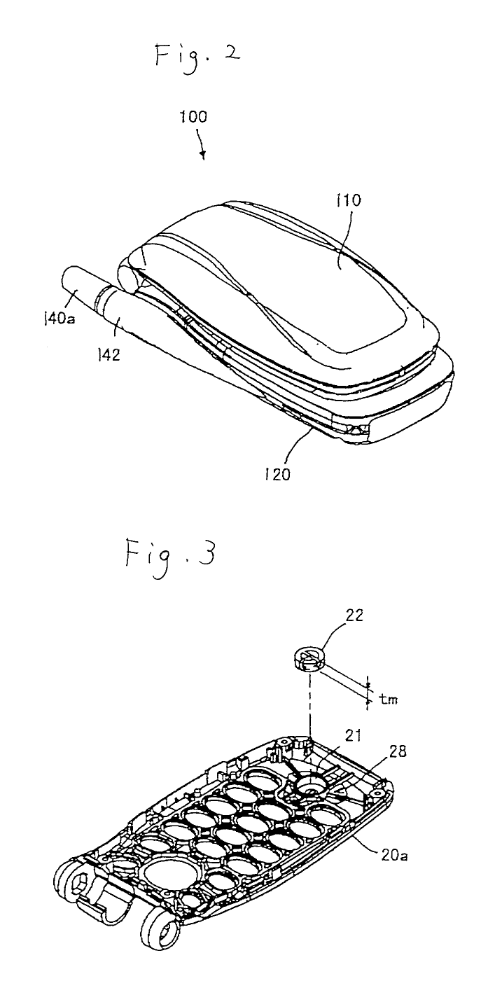

The telephone transmitter unit in the present embodiment, as its accommodation condition is shown in FIG. 3, includes: the microphone 122 fixed by inserting into a rib 121 integrally formed with the key operation section 124 side of an inside casing piece 120a of the lower casing 120; and a transmission unit (not shown) for inputting the information such as the voice obtained by the microphone 122, into the primary circuit board. In a microphone accommodation portion 128 in which the microphone 122 in the lower casing 120 is accommodated, because the battery 126 is accommodated on the outside surface of the lower casing 120, particularly the regulation of the thickness is severe, and it is necessary that the thickness of the microphone accommodation portion 128 of the lower casing 120 is set larger due to the thickness tₘ of the microphone 122 itself.

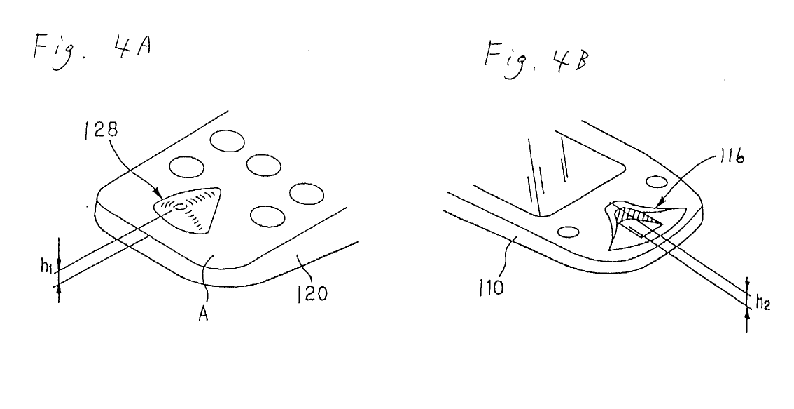

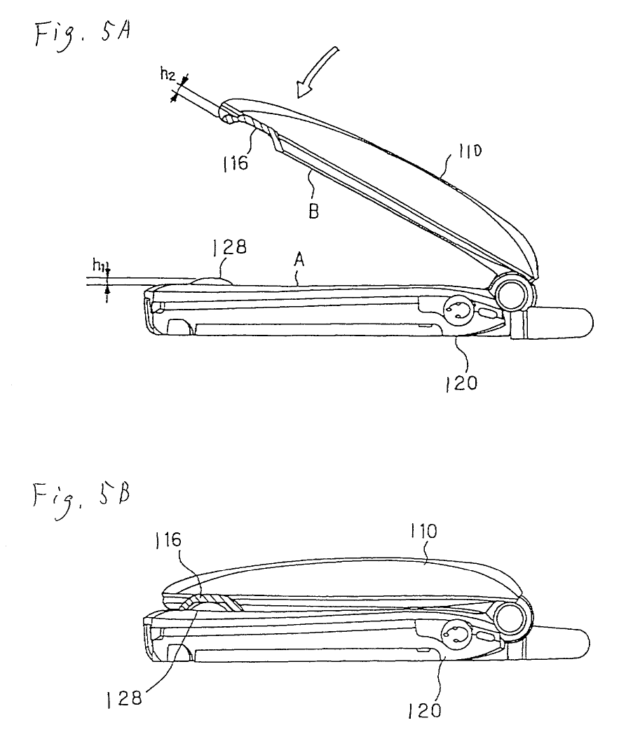

Accordingly, in the present embodiment, the microphone accommodation portion 128 of the lower casing 120 is formed into a convex shape having the smooth curved surface which is protruded from the casing surface A locally by the thickness h₁ as shown in FIG. 4A. Thereby, to the area of the lower casing 120 except for the microphone accommodation portion 128 for which the thickness is necessary, the portable telephone device 100 can be low-profile, without increasing the thickness. Further, when the microphone accommodation portion 128 is protruded, the sound collection property of the voice is improved, and because the protruded convex portion is formed of the smooth curved surface, the feeling of the contact becomes good, and the shape is excellent in a sense of beauty.

On the one hand, in the receiver unit of the upper casing 110, a receiver accommodation portion 116 in which a receiver having a speaker 112 of the receiver unit is accommodated as shown in FIG. 4B, is formed into the concave shape of depth h₂ (h₂>h₁) in which the height h₁ of the microphone accommodation portion 128 of the lower casing 120 at the time of folding can be fitted. In this manner, when the receiver accommodation portion 116 is formed into the concave shape, because there is no protruded portion, the hearing feeling becomes good, and when the sound from the receiver unit is echoed by the concave portion, the sound can be easily heard. In this connection, when the receiver main body is arranged at a position which is slightly moved to the side from the center position of the receiver accommodation portion 116, the decrease of the arrangement space in the height direction is avoided by the concave portion.

As described above, when the microphone accommodation portion 128 and the receiver accommodation portion 116 are respectively formed into the concave shape and convex shape, at the time of folding of the portable telephone device 100, the convex portion of the microphone accommodation portion 128 is fitted in the concave portion of the receiver accommodation portion 116. The fitting condition is shown in FIG. 5, by using a partial sectional view. FIG. 5A shows a condition in which the upper casing 110 and the lower casing 120 are opened, and FIG. 5B shows a condition in which the upper casing 110 and the lower casing 120 are folded.

As shown in FIG. 5A, the microphone accommodation portion 128 is protruded by the height h₁ from the inside surface A of the lower casing 120, and the receiver accommodation portion 116 is recessed by the depth h₂ from the inside surface B of the upper casing 110. Then, when each of casings 110 and 120 is folded, as shown in FIG. 5B, the microphone accommodation portion 128 and the receiver accommodation portion 116 are opposite to each other and overlapped, and the convex portion of the microphone accommodation portion 128 is fitted in the concave portion of the receiver accommodation portion 116. Thereby, the increase of the thickness of the portable telephone device 100 when folded can be prevented, and even when the thick accommodation space is locally necessary, the reduction of the thickness can be attained.

In this connection, in the above embodiment, the microphone accommodation portion 128 is formed into the convex shape, and the receiver accommodation portion 116 is formed into the concave shape, however, corresponding to change of the design, these concave and convex may be the structure in which these are appropriately reversed. Further, not only for the microphone or receiver, but also for other mounting parts, in the same manner, when the convex portion and the concave portion are provided in the casing, the increase of the local thickness can be absorbed, and the reduction of the thickness as the whole can be attained.

(Embodiment 2)

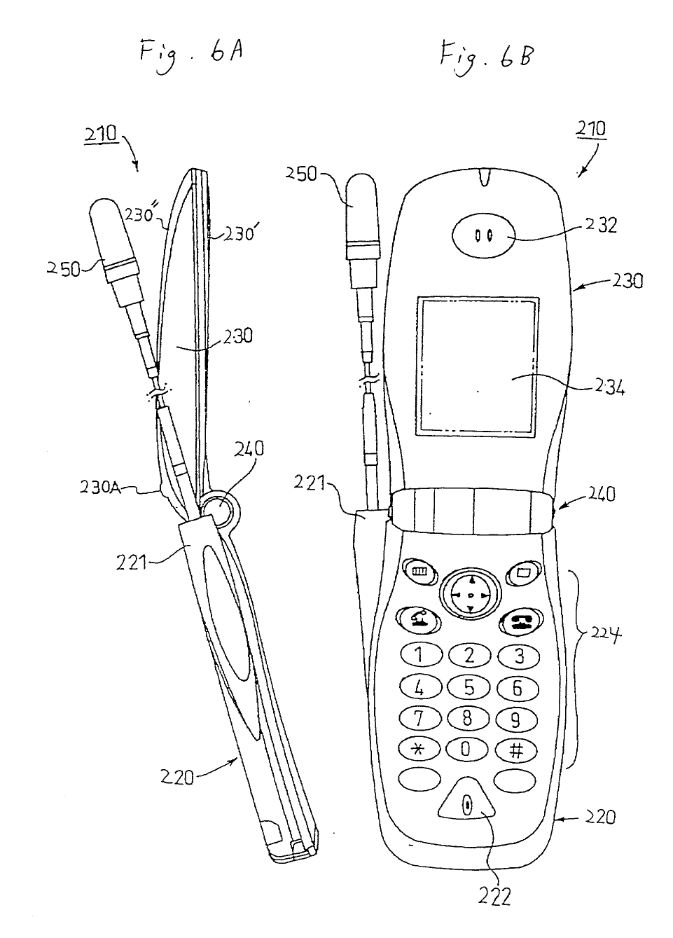

FIG. 6 is a view showing a condition in which the upper casing of the portable telephone device is opened from the lower casing to the maximum according to the second embodiment, and FIG. 6A is its side view and FIG. 6B is its front view.

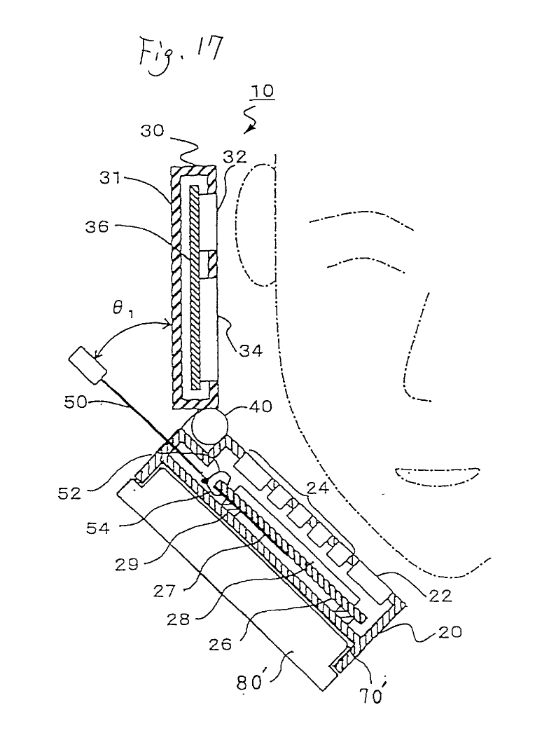

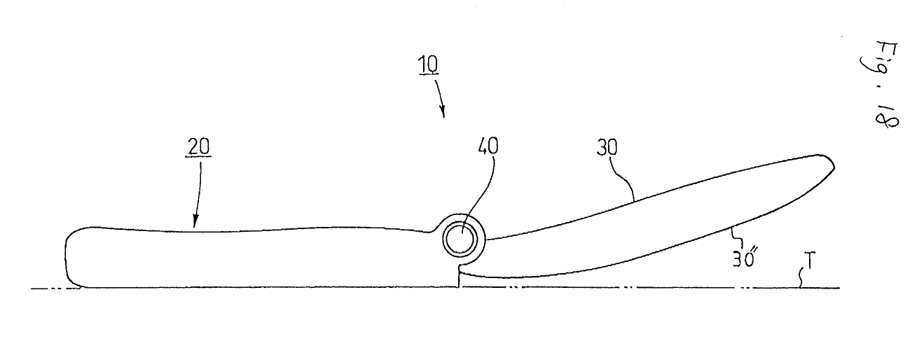

In the drawing, numeral 210 is a portable telephone device including a lower casing 220, upper casing 230 and a hinge portion 240 by which these are rotatably connected with each other. Except for the shape of the upper casing 230, all other potions are the same as in FIG. 16. That is, the lower casing 220 is provided with a microphone 222 to input the voice from the user of the portable telephone device 210, and operation key 224 and the antenna accommodation portion 221. As the operation key, there is the operation key 224 including a switch for the power source on/off of the portable telephone device 210, numeral keys for alphanumeric characters input, and function keys to select and conduct each kind of functions. The antenna accommodation portion 221 is provided on one side surface of the lower casing 220 as shown in the drawing, and therein, all remaining portions except a portion of the upper portion of the antenna 250 are accommodated. In the upper casing 230, a speaker 232 and a display portion 234 are arranged on the surface 230′ of the front side. The hinge portion 240 combines the lower casing 220 and upper casing 230 respectively rotatably with each other, and electrically insulates the lower casing 220 and the upper casing 230. When the portable telephone device 210 is used, these casings are opened by a predetermined angle, for example, by a slightly smaller angle than 180°. The antenna 250 is a whip antenna which can be extended and accommodated, and when the antenna is accommodated, the antenna 250 is accommodated in the antenna accommodation portion 221 by leaving the tip portion. Further, when the portable telephone device 210 is used, the antenna 250 is pulled out in the direction of the rear surface 231 of the casing 230 opposite to the human body. Then, when the antenna 250 is extended, as shown in FIG. 17, an angle of a predetermined angle θ1 is formed between the antenna 250 and the cover rear surface 231 of the upper casing 230.

In such the portable telephone device 210, according to the second embodiment of the present invention, a convex portion 230A is formed on the rear surface of the upper casing 230, that is, on the surface 230″ (hereinafter, called upper casing rear surface) that is opposite surface to the front side surface 230′ on which the speaker 232 and the display portion 234 are arranged. The size of the convex portion is set to such a size that the top edge of the of the convex portion 230A other than the bottom portion of the lower casing 220 contacts with the plane, when the upper casing 230 is placed in the plane in the condition that the upper casing 230 is opened from the lower casing 220. When such the convex portion is formed, in the case where the upper casing 230 is placed on the desk in the condition that the upper casing 230 is opened from the lower casing 220, because the top edge of the of the convex portion 230A other than the bottom portion of the lower casing 220 contacts with the surface of the desk, the area supporting the portable telephone device 210 is larger than the conventional device, and accordingly, the stability becomes good.

It is preferable that the position in the upper casing 230 of the convex portion 230A is provided on the center line in the longitudinal direction of the upper casing 230 when the convex portion 230A is formed into a point shape, and the number of the convex portion is 1. According to this, the contact area on the desk is most large, and the portable telephone device 210 is stable.

In the same manner, when the convex portion 230A is a point shape, and the number of the convex portion is 2, it is preferable that the convex portion 230A is provided on the line which is at a right angle with the center line, and on positions which are symmetrical with the center line. Further, when the convex portion 230A is linear, it is preferable that the convex portion 230A is provided on a line located at a right angle with the center line. In any case, the contact area on the desk is most large, and the balance of the left and the right is obtained with the centerline, and the portable telephone device 210 is stable.

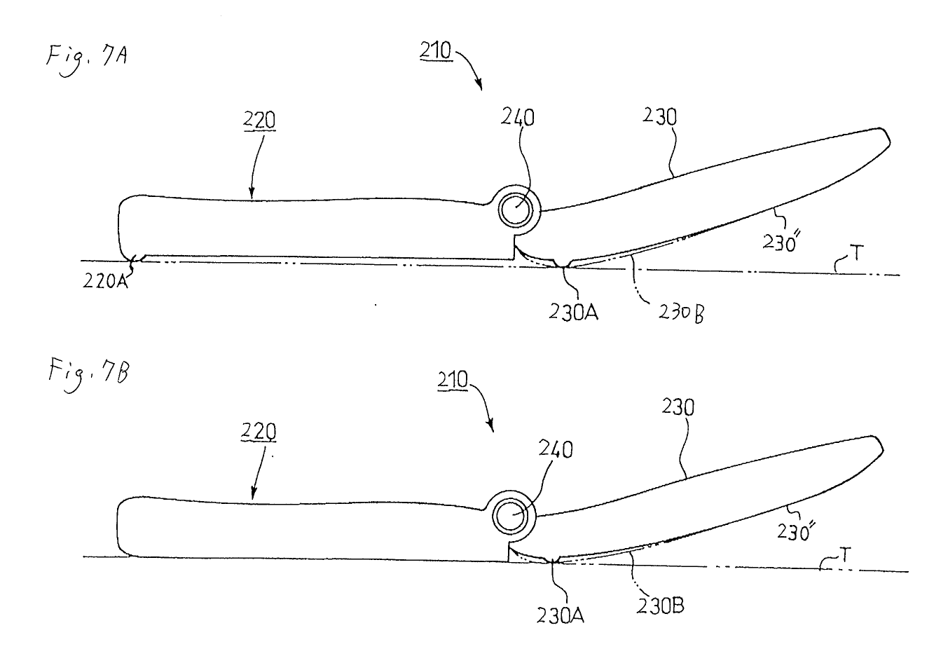

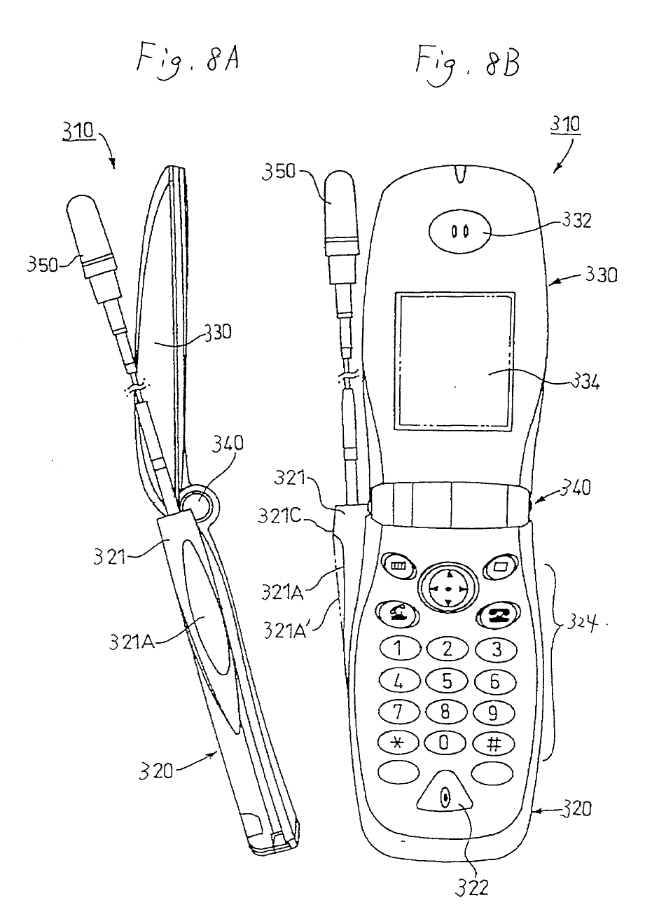

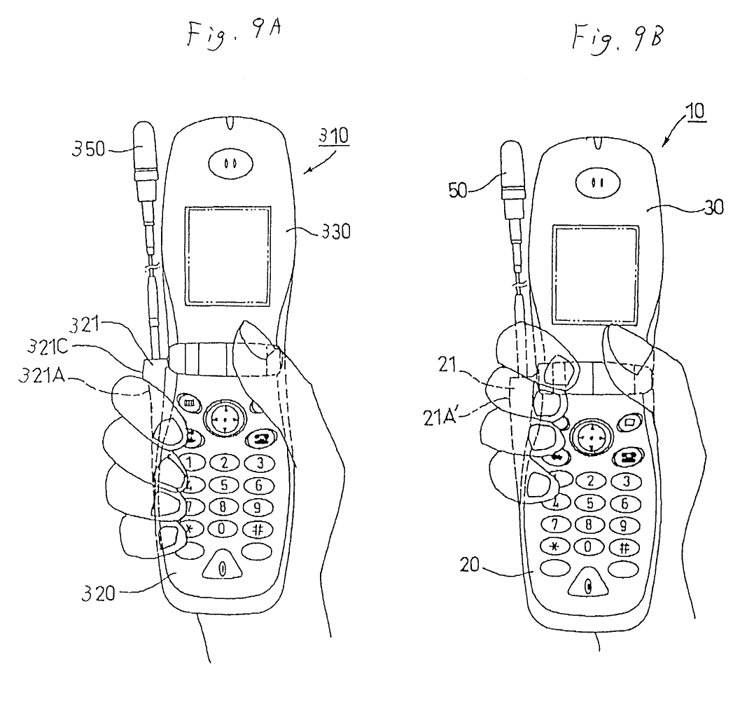

FIG. 7 is a view generally showing a condition that the portable telephone device 210 as shown in FIG. 6, is placed on the disk while the upper casing 230 is opened from the lower casing 220. FIG. 7B is an example in which the portable telephone device 210 is supported by the whole bottom portion of the lower casing 220, and the convex portion 230A of the upper casing rear surface 230″, and FIG. 7A is an example in which the portable telephone device 210 is supported by a portion of the bottom portion of the lower casing 220, particularly, by a lower side portion 220A of the bottom surface of the lower casing 220 and the convex portion 230A of the upper casing rear surface 230″. The lower side portion 220A is provided on the lower side of the lower casing 220, that is opposite side of a side connected to the hinge portion 240.

In the drawings, in both cases, the portable telephone device 210 is in the condition that the upper casing 230 is opened from the lower casing 220 at the maximum around the hinge portion 240 as the center of rotation, and in this condition, it can be seen that, other than lower casing 220, the convex portion 230A of the upper casing rear surface 230″ is in contact with the horizontal surface T of the desk.

According to this, because, other than the base portion of the lower casing 220, the top edge of this convex portion is brought into contact with the desk surface, the area supporting the portable telephone device 210 is larger than the conventional device, accordingly, it is stable.

Further, even when the portable telephone device 210 is placed in the condition while the upper casing 230 is opened, because the weight of the upper casing itself is applied onto the desk, and the hinge portion 240 is not burdened with the weight, the trouble of the hinge portion 240 hardly occurs.

In the case of FIG. 7B, it is originally necessary that the all bottom portion of the lower casing 220 is formed flat, and maintained, and when the unevenness is caused by any cause when the portable telephone device 210 is used, there is a possibility that the stability becomes poor, however, in contrast to this, in the case of FIG. 7A, because the portable telephone device 210 is supported by the lower side potion 220A of the bottom surface of the lower casing 220, and the convex portion 230A of the upper casing rear surface, a portion between them is floated from the desk surface, accordingly, even when the unevenness is caused by any cause when the portable telephone device 210 is used, the stability is not influenced.

Both of FIG. 7A and 7B show examples in which the convex portion 230A is positively formed on the upper casing rear surface, however, the convex portion is not always necessary.

According to the third embodiment of the present invention, as shown by the imaginary line 230B in FIGS. 7A and 7B, when the curved surface of the upper casing rear surface 230″ is a curved surface passing through the tip portion of the convex portion 230A, the same effect can be obtained.

In the above description, an example of the portable telephone device in which the antenna 250 is provided in the lower casing 220 side, is described, however, of course, the present invention is not limited to this, but it is needless to say that it can also be applied to the portable telephone device in which the antenna 250 is provided in the upper casing 230 side. When it is applied to such the portable telephone device whose upper casing is weightier by the self weight of the antenna 250, it can be said that the effect is rather larger.

Further, when the present invention is applied to also the radio devices whose upper casing is opened and closed other than the example of the portable telephone device, the same can be adapted.

(Embodiment 3)

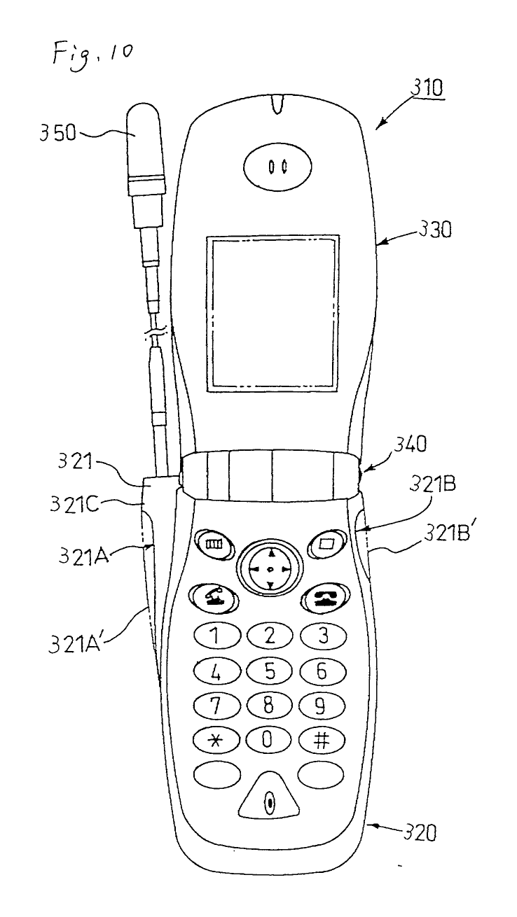

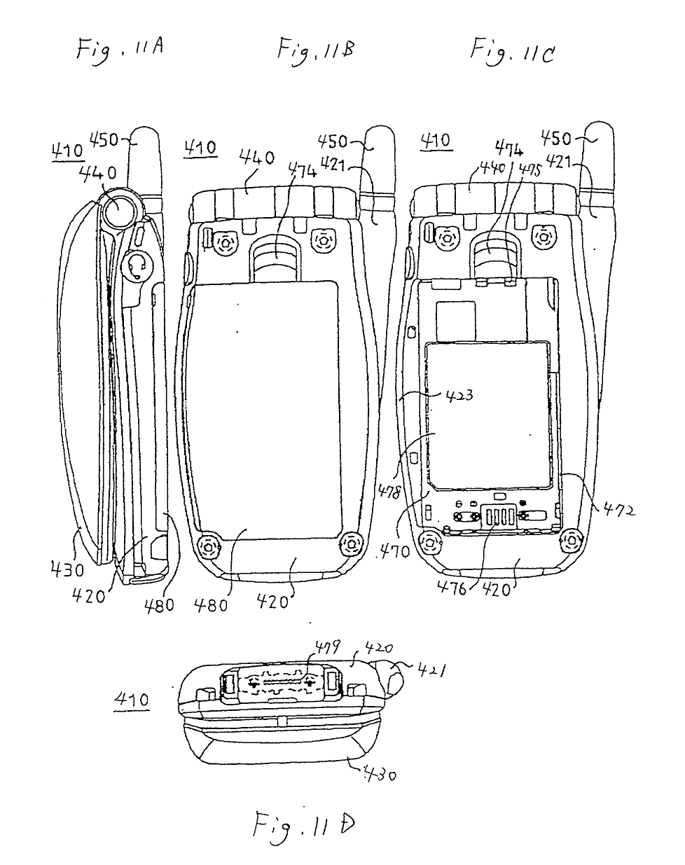

FIG. 8 is a view showing the condition that the upper casing of the portable telephone device is opened from the lower casing to the maximum according to the third embodiment, and FIG. 8A is its side view and FIG. 8B is its front view.

In the drawings, numeral 310 is the portable telephone device, including lower casing 320, upper casing 330 and a hinge portion 340 by which these are rotatably connected with each other. Except the shape of the lower casing 320, all of the function of the lower casing 320 and the shape and the function of the upper casing 330 and the hinge potion 340 are the same as in FIG. 16. That is, the lower casing 320 is provided with a microphone 322 to input the voice from the user of the portable telephone device 310, and operation key 324 and the antenna accommodation portion 321. As the operation key, there is the operation key 324 including a switch for the power source on/off of the portable telephone device 310, numeral keys for alphanumeric characters input, and function keys to select and conduct each kind of functions. The antenna accommodation portion 321 is provided on one side surface side of the lower casing 320 as shown in the drawing, and therein, all remaining portions except a portion of the upper portion of the antenna 350 are accommodated. In the upper casing 330, a speaker 332 and a display portion 334 are arranged on the front surface. The hinge portion 340 combines the lower casing 320 and upper casing 330 respectively rotatably with each other, and electrically insulates the lower casing 320 and the upper casing 330 from each other. When the portable telephone device 310 is used, these casings are opened by a predetermined angle, for example, by a slightly smaller angle than 180°0, and used. The antenna 350 is a whip antenna which can be extended and accommodated, and when the antenna is accommodated, the antenna 350 is accommodated in the antenna accommodation portion 321 by leaving the tip portion. Further, when the portable telephone device 310 is used, the antenna 350 is pulled out in the direction of the rear surface 331 of the casing 330 opposite to the human body. Then, when the antenna 350 is extended, as shown in FIG. 17, an angle of a predetermined angle θ1 is formed between the antenna 350 and the cover rear surface 331 of the upper casing 330.

In such the portable telephone device 310, according to the present invention, the outer shape of the antenna accommodation portion 321 is formed, not into the shape shown by the imaginary line of the smooth curve 321A′ as the conventional one, but into the concave portion as shown by the solid line 321A. The shape of this concave portion is preferable when the curvature is equal to the curvature of the cross sectional shape of the fingers or not smaller than that. According to the concave portion formation of such the shape, the fingers are easily put on the concave portion, and when the portable telephone device 310 is used, the user of the portable telephone device 310 unconsciously puts the first finger on the concave portion. Further, when the first finger is put on the concave portion, the protruded portion 321C just above the concave portion is engaged with the finger, and even when the portable radio device is not gripped so firmly, it is hardly dropped, thereby, the grip property is increased.

FIG. 9A shows the condition in which the user naturally grips the portable telephone device 310 in FIG. 8 of the third embodiment by the right hand. As shown in the drawing, it can be seen that the user puts the first finger on the concave portion 312A below the protruded portion 321C. This is for the reason why a portion of the protruded portion 321C just above the finger put concave portion 321A interferes the finger in such a manner that the first finger is hardly put on the protruded portion 321C and the antenna portion above it, accordingly, the first finger is naturally put on the concave portion. Accordingly, the first finger does not touch the antenna.

FIG. 10 shows another example of this embodiment, and the concave portion 321B is also formed on a portion 321B′ near the opposite portion of the lower casing 320 of the accommodation portion 321 in which the antenna 350 is accommodated.

According to the structure described above, because the human has the habit to unconsciously grasp the narrowest portion, when the concave portion 321B is also formed on the opposite portion 321B′ on the reverse side of the concave portion 321A of the antenna accommodation portion 321, the distance connecting the concave portion 321A to the concave portion 321B is the shortest in the lower casing 320, accordingly, this shortest portion is grasped, thereby, the provability that the finger is put on the finger put concave portion 321A on the antenna side, is more increased.

Further, according to this structure, even in the case of the people whose hand of good efficacy is the left hand, because the people grasps this shortest portion, the provability that the thumb is put on the finger put concave portion 321A on the antenna side, is more increased than in the case of no concave portion.

The above description is made by using an example of the portable telephone device, however, the present invention is not limited to this, but when a device is a radio equipment with the antenna, which can be held by one hand, the same thing can be applied for it.

(Embodiment 4)

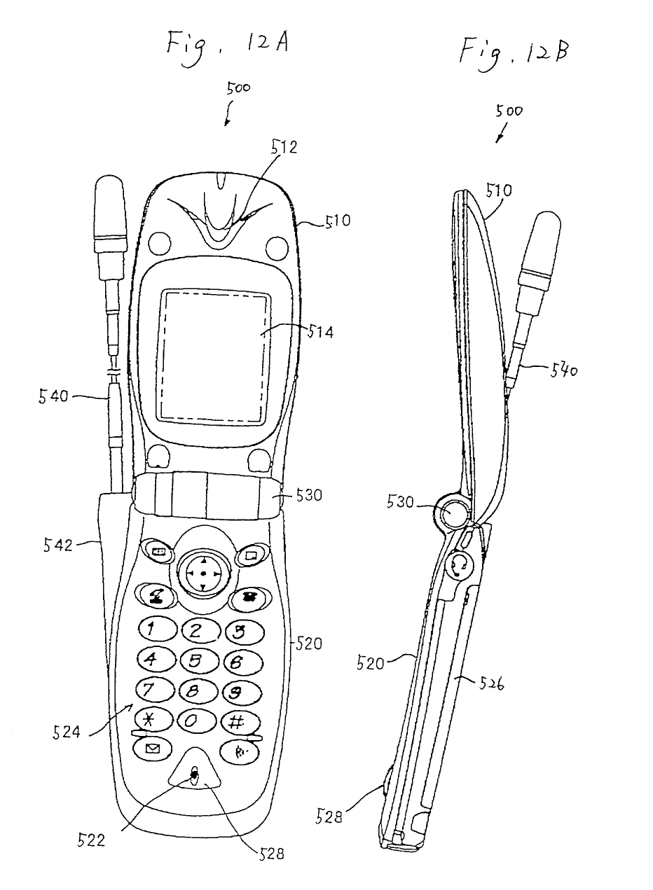

By using FIG. 11, the fourth embodiment of the invention will be described below.

FIG. 11 is a view showing the condition that a upper casing of a potable telephone device is closed being overlapped on a lower casing, and FIG. 11A is a side view of the lower casing in which a battery pack is housed, and FIG. 11B is a plan view in which FIG. 11A is viewed from the bottom surface side, FIG. 11C is a plan view in which the lower casing from which the battery pack is removed, is viewed from the bottom surface side, and FIG. 11D is a front view of FIG. 11B.

In the drawings, numeral 410 is a portable telephone device, and this portable telephone device 410 includes a lower casing 430 and upper casing 420, and hinge portion 440 combining these casings respectively rotatably.

The hinge portion 440 combines the lower casing 420 and the upper casing 430 with each other respectively rotatably, and electrically insulates the lower casing 420 and the upper casing from each other.

The antenna 450 is a whip antennas which can be extended and accommodated, and when the antenna is accommodated, a tip portion of the antenna 450 is left, and as shown in the drawing, the antenna 450 is accommodated in the antenna accommodation portion 421.

In such the portable telephone device 410, according to the present invention, a battery pack accommodation unit 470 is parallely arranged at the side of an antenna accommodation portion 421. That is, as can be seen from the drawing, the battery pack accommodation unit 470 is provided between the antenna accommodation portion 421 and the other side surface portion 423 of the lower casing 420. Then, in this battery pack accommodation unit 470, a protrusion 475 interlocking with a slide knob 474, power source spring terminal 476, and name plate 478 are arranged. Numeral 479 is an I/O terminal, and normally, it is closed by a cover.

Numeral 480 is a battery pack accommodated in the battery pack accommodation unit 470. This battery pack 480 is, as can be seen in FIG. 11A and FIG. 11B, formed into a shape in which it is exactly accommodated in the battery pack accommodation unit 470, and is provided with a groove portion and a power source terminal (both are not shown) respectively corresponding to the protrusion 475 and the power source spring terminal 476 in the battery pack accommodation unit 470.

In the manner describe above, according to this embodiment, the antenna and the battery pack, which are respectively thick, are not overlapped up and down as shown in FIG. 17, but are arranged parallely, thereby, the low-profile portable radio device can be obtained.

Further, as shown in FIG. 11A, because only single side of the side surfaces of the battery pack 480 is exposed, the mounting backlash is hardly felt.

Then, because the antenna 450 is accommodated in the lower casing 420 side, although it is required that the strength of the lower casing 420 is increased. In order to secure the rigidity of the lower casing 420, a rib 472 is provided along the antenna accommodation portion 421 in the battery pack accommodation unit 470.

According to such the structure, the rigidity of the lower casing 420 can be secured, and the requirement described above can be satisfied.

In the above description, an example of the portable telephone device is described, however, the present invention is not limited to this, but, when the device is a radio equipment having an antenna and using a battery pack, the same can be applied for it.

(Embodiment 5)

Referring to the drawings, the fifth embodiment of the portable radio device according to the present invention will be detailed below. In the present embodiment, as a specific example of the portable radio device, a folding portable telephone device will be described.

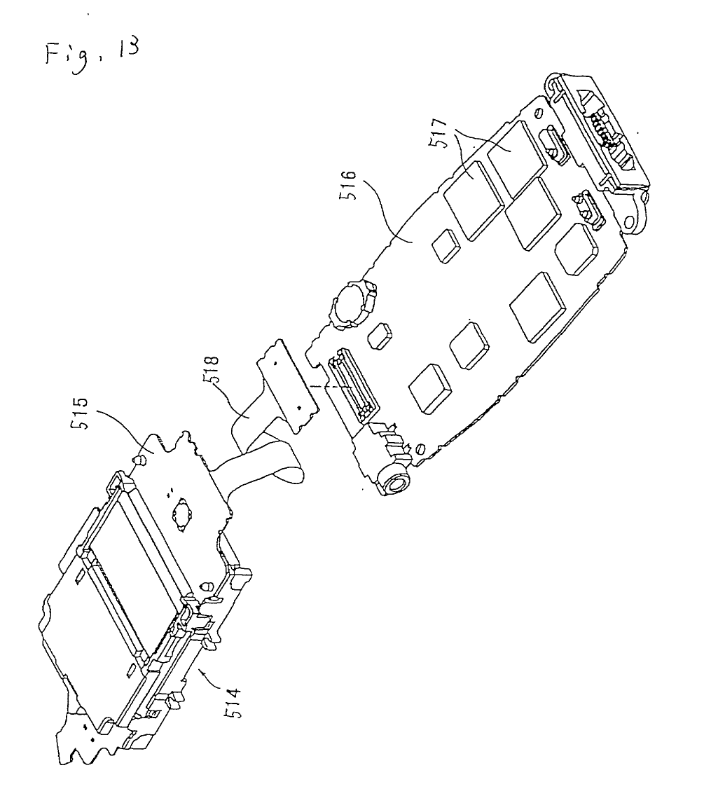

FIG. 12 is a view of the whole appearance of a folding portable telephone device, and FIG. 12A is a front view, and FIG. 12B is a side view.

As shown in FIG. 12, a casing of the folding portable telephone device 500 has the structure in which it is divided into an upper casing (the second casing) 510 and a lower casing (the first casing) 520, and these upper casing 510 and lower casing 520 are combined with each other respectively rotatably by a hinge portion 530. When the upper casing 510 of the folding portable telephone device 500 is rotated around the hinge portion 530, the folding portable telephone device can be folded, up to a degree that the upper casing 510 comes into contact with the lower casing 520 or almost contact with the lower casing.

The upper casing 510 and the lower casing 520 have respectively a combination of a front case and a rear case, and this side case in FIG. 12A (the left side case in FIG. 12B) is the front case of respective ones.

In the upper casing 510 of this portable telephone device 500, a receiver unit 512 having a receiver to emit sounds such as voices (speaker) and an information display portion 514 such as a liquid crystal display panel are provided. In the lower casing 520, a transmitter unit 528 having a microphone 522 to detect sounds such as voices, key operation portion 524, and battery 526 are provided.

Further, on one side surface (left side in FIG. 12A) of the lower casing 520, an antenna accommodation portion 542 to accommodate the antenna 540 is provided in almost parallel with the longitudinal direction of the lower casing 520. This antenna is, for example, a whip antenna, and provided so that it can be extended and contracted, in the lower casing 520. That is, the antenna 540 is pulled out to the upper casing 510 side as shown in FIG. 12 when it is extended, and is extended to the direction apart from the human body side at the time of use, and on the one hand, at the time of accommodation, the tip portion is left and the antenna 540 is accommodated into the antenna accommodation portion 542. On the rear surface of the lower casing 520, the battery 526 which is comparatively weighty, is attached detachably, and when the position of the center of gravity of the portable telephone device 500 is positioned in the lower casing 520, the grip stability can be obtained.

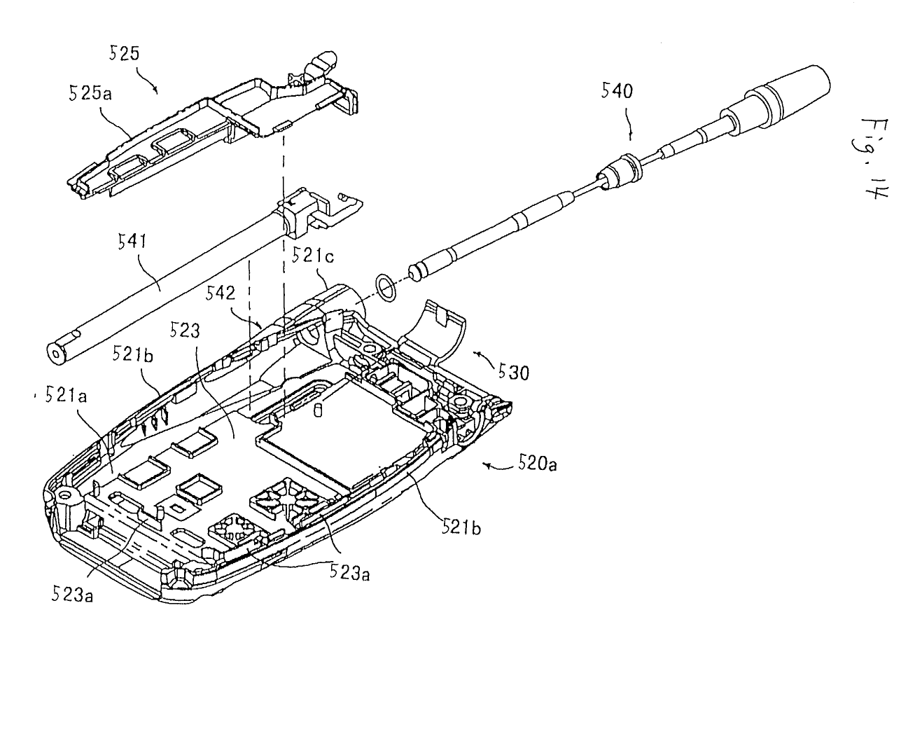

In the upper casing 510, a secondary circuit board 515 (refer to FIG. 13) including a driver circuit of the information display portion 514, and a speaker of the receiver unit 512 are accommodated, and these are fixed in the upper casing 510 by a supporter which is integrally molded with the upper casing 510.

In the lower casing 520, a primary circuit board 516 (refer to FIG. 13) including the radio circuit in which electronic parts such as a CPU to process each kind of signals and a memory to store each kind of information, are mounted, and a microphone 522 of a transmitter unit 528 are accommodated. These are fixed in the lower casing 520 by a supporter which is integrally molded with the lower casing 520.

Further, on the primary circuit board (the lower surface of the primary circuit board 516 in FIG. 13) in the lower casing 520, a plurality of switches having diaphragms are provided. On these switches, a key sheet is arranged. On the key sheet, a switch for a power source on/off of the portable telephone device 500, and each kind of button keys such as keys for alphanumeric characters input, and function keys for selecting and conducting each kind of functions, are provided.

The description returns to FIG. 12. The key operation portion 524 of the lower casing 520 is structured in such a manner that a key top portion of each kind of buttons is protruded from holes provided on the front case of the lower casing 520.

In the above portable telephone device 500, because the antenna 540 is provided on the lower casing 520 side, there is an advantage that the connection distance to the radio circuit accommodated in the lower casing 520 is satisfactorily short, and the power consumption can be suppressed, and the receiving sensibility is increased.

As shown in FIG. 13, the primary circuit board 516 and the secondary circuit board 515 are connected through the flexible board 518, and the sending and receiving of each kind of transmission signals is conducted between both circuit boards. In this connection, the flexible board 518 connects the circuit boards with together through the inside of the hinge portion 530 (refer to FIG. 12).

The surface (the upper surface in FIG. 13) on which each kind of electronic parts 517 are mounted, of the primary circuit board 516, is opposite to the support plate of the rear case, which will be described below.

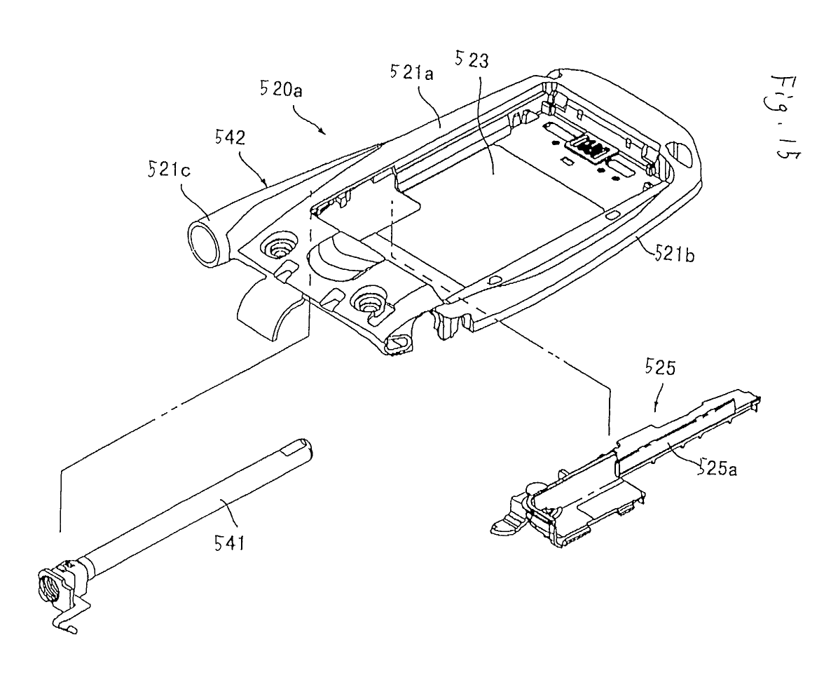

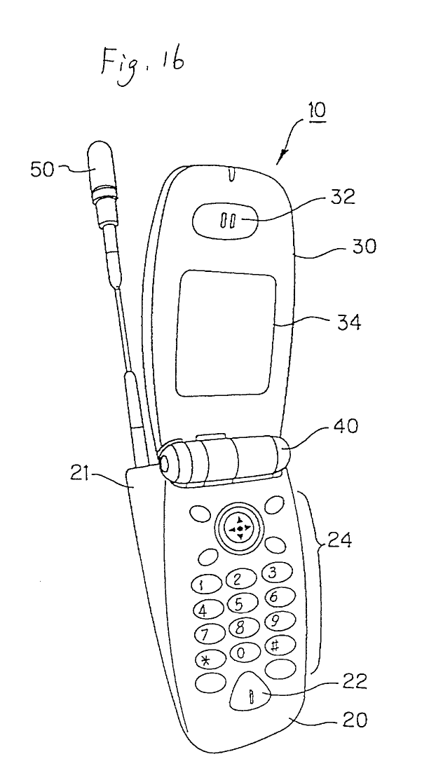

FIG. 14 is a perspective view showing the inner surface side of the rear case 520a of the lower casing, and FIG. 15 is a perspective view showing the outer surface side of the rear case 20a. In this connection, in FIG. 15, an illustration of the antenna 540 is neglected.

Herein, the rear case 520a is formed of synthetic resins. As shown in FIG. 14, the rear case 520a has a flat plate portion 521a and a side wall portion 521b. The flat plate portion 521a may be curved. On the inner surface (in the drawing, the upper surface) of the flat plate portion 521a, a support plate 523 to support the primary circuit board 516 (refer to FIG. 13) is integrally molded. The primary circuit board 516 is practically supported by a support wall 523a vertically provided along a side of the opposite side to a side of the antenna accommodation portion 542 side of the support plate 523. The support wall 523a is not provided on a side of the antenna accommodation portion 542 side of the support plate 523. The support plate 523 is arranged on the primary circuit board 516 side in such a manner that a step increment is formed to the flat plate portion 521a. Metal such as an aluminum is evaporated on the inner surface (upper surface in the drawing) of the support plate 523 and the support wall 523a.

The side wall portion 521b is vertically provided along a side (a side in the longitudinal direction) of the end portion in the width direction of the flat plate portion 521a. The side wall portion 521b of the antenna accommodation portion 542 side is formed into the almost cylindrical shape on the upper side (hinge portion 530 side), and the antenna 540 is inserted into it.

The support plate 523 is not extended to the side wall portion 521b on the antenna accommodation 542 side. That is, a concave portion is partitioned by the side wall portion 521b on the antenna accommodation 542 side, the adjoining flat plate portion 521a and the end portion in the width direction of the support plate 523. This concave portion is arranged on the lower side than the almost cylindrically formed portion 521c of the side wall portion 521b. A cylindrical guide member 541 to guide the extension and contraction of the antenna 540 in the casing is mounted in the concave portion so that the axis line of the almost cylindrically formed portion 521c of the side wall portion 521b coincides with the axis line of the guide member 541.

The auxiliary support plate 525 is mounted in the rear case 520a so that the concave portion in which the guide member 541 is mounted, is filled in, and it forms an almost equal surface to the support plate 523. Herein, the auxiliary support plate 525 is formed of synthetic resins. The auxiliary support plate 525 is provided with the auxiliary support wall 525a which is vertically provided along a side of the antenna accommodation portion 542 side. In the auxiliary support plate 525, a predetermined portion of the auxiliary support wall 525a is engaged by the engagement protrusion provided on the side wall portion 521b, and a predetermined portion of a side of the opposite side to the side at which the auxiliary support wall 525a is vertically provided, is engaged by the engagement protrusion provided on the support plate 523. On the inner wall (in the drawing, the upper surface) of the auxiliary support plate 525 and the auxiliary support wall 525a, aluminum is evaporated.

The peripheral portion of the primary circuit board 516 (refer to FIG. 13) is supported by the support wall 523a vertically provided on the support plate 523, and the auxiliary support wall 525a vertically provided on the auxiliary support plate 525. At this time, the electronic parts 517 (refer to FIG. 13) is arranged in the space among the primary circuit board 516, support plate 523 and auxiliary support plate 525. The space between the electronic parts 517 and antenna 540 are shielded by the auxiliary support wall 525a of the auxiliary support plate 525 so that the influence of electromagnetic waves is not generated.

As described above, the support wall 523a is not provided on a side of the antenna accommodation portion 542 side of the support plate 523. When the support wall is provided on a side of the antenna accommodation portion 542 side of the support plate 523, because the support wall interferes with electronic parts 517, it is necessary that the arrangement of the electronic parts 517 is changed, and the practical mounting area of the primary circuit board 516 (refer to FIG. 13) is narrowed. Herein, the support wall 523a is not provided on a side of the antenna accommodation portion 542 side of the support plate 523, and instead of it, the auxiliary support wall 525a is provided on the auxiliary support plate 525. That is, the auxiliary support plate 525 extends the support plate 523 toward the antenna accommodation portion 542 side. According to this, the interference between the electronic parts 517 and the antenna 540 is prevented, and further, the mounting area of the primary circuit board 516 can be increased.

According to the folding portable telephone device 500 as described above, when, after the guide member 541 of the antenna is attached in the rear case 520a, the auxiliary support plate 525 is mounted on the rear case 520a, the support plate 523 is extended to the vicinity of the antenna accommodation potion 542 by the auxiliary support plate 525. Further, when the auxiliary support plate 525 is mounted so as to fill in the concave portion of the rear case 520a, the strength (rigidity) of the rear case 520a is increased. Further, when the auxiliary support wall 525a shields between the antenna 540 and the primary circuit board 516, the bad influence from the primary circuit board 516 is prevented from affecting the antenna 540.

In this connection, the present invention is not limited to the embodiment described above, but, the appropriate variation and modification may be possible.

For example, the present invention is effective when the casing is formed of the metal or metal containing material.

According to this portable radio device, in the case where the fist and second casings are folded, when the convex portion protruded from the surface of the inside of the first casing is accommodated in the concave portion formed by being recessed from the surface of the inside of the second casing provided opposite to this convex portion, even when the sufficient accommodation space for the parts can not be obtained in the first casing, by using the space in the first casing formed by the convex portion, the parts can be accommodated. Further, when the concave portion of the second casing is formed opposite to the convex portion of the first casing, for the other portion except for the convex portion in which the thickness is necessary, the first casing can be maintained in the low-profile, and the increase of the thickness of the portable radio device when each of casings is folded, can be prevented. Accordingly, even when thicker accommodation space is necessary, without increasing the thickness of the whole device, the thickness of the device when the casings are folded, can be made thin.

Further, according to the portable radio device of the present invention, when it is placed on the plane of the desk in the condition that the upper casing is opened from the lower casing, because the bottom surface of the lower casing and a portion of the upper casing are brought into contact with the plane, the stability becomes good, and it is hardly tilted.

Moreover, according to the portable radio device of the present invention, because the finger put concave portion is formed near the antenna accommodation portion of the lower casing, when the portable radio device is used, the user does not touch the antenna portion of the lower casing, and the lowering of the antenna gain thereby, and the influence on the human body due to the radio wave can also be eliminated.

Further, when the portable radio device is held by the hand at the time of transmission, because the finger is in contact with the concave portion, the protruded portion just above it conducts the engagement action, thereby, even when the portable radio device is not gripped so firmly, it is hardly dropped, and the grip property is increased.

Furthermore, as described above, according to the portable radio device of the present invention, when the battery pack accommodation unit is provided between the antenna accommodation potion and the other side surface portion of the lower casing, the low-profile portable radio device can be obtained, and further, because only single side of side surfaces of the battery pack is exposed, the mounting backlash is hardly felt.

Further, when a rib is provided along the antenna accommodation portion in the battery pack accommodation unit, the rigidity of the lower casing can be secured.

Furthermore, as described above, according to the present invention, when the support plate of the casing is extended, a predetermined mounting area in the circuit board and the casing strength can be secured, and the bad influence from each kind of circuits on the circuit board can be prevented from affecting the antenna.

What is claimed is:

1. A portable radio device comprising:
a first casing;
a second casing;
a hinge portion to connect together the first and second casings respectively roatatably;
a convex portion provided on the inside surface of the first casing and protruded from the surface of the inside; and
a concave portion provided on the inside surface of the second casing,
wherein the convex portion and the concave portion are fitted when the first and second casings are folded.

2. The portable radio device according to claim 1, wherein a telephone transmitter unit to detect sounds is accommodated in a space in the first casing formed by the convex portion.

3. The portable radio device according to claim 2, wherein a receiver unit to emit sounds is accommodated in a position of the concave portion.

4. A portable radio device comprising:
a first casing in which a primary circuit board is accommodated;
a second casing; and
a hinge portion to connect together the first and second casings respectively roatatably;
wherein, when the device is placed on the plane in the condition in which the second casing is opened from the first casing, a bottom surface of the first casing and a contact portion of the second casing are brought into contact with the plane.

5. The portable radio device according to claim 4, wherein the contact portion is provided on the second casing near the hinge portion.

6. The portable radio device according to claim 4, wherein the contact portion is formed into a convex portion.

7. The portable radio device according to claim 6, wherein the convex portion is formed on a center line in the longitudinal direction of the second casing.

8. The portable radio device according to claim 6, wherein the convex portion is formed on a line at a right angle with the center line of the second casing.

9. A portable radio device comprising:
a first casing in which a primary circuit board is accommodated;
a second casing; and
a hinge portion to connect together the first and second casings respectively roatatably;
wherein, when the device is placed on the plane in the condition in which the second casing is opened from the first casing, a lower side portion of bottom surface of the first casing and a contact portion of the second casing are brought into contact with the plane.

10. The portable radio device according to claim 9, wherein the contact portion is provided on the second casing near the hinge portion.

11. The portable radio device according to claim 9, wherein the contact portion is formed into a convex portion.

12. The portable radio device according to claim 11, wherein the convex portion is formed on a center line in the longitudinal direction of the second casing.

13. The portable radio device according to claim 11, wherein the convex portion is formed on a line at a right angle with the center line of the second casing.

14. A portable radio device comprising:
a first casing in which an antenna and a primary circuit board are accommodated;
a second casing;
a hinge portion to connect together the first and second casings respectively roatatably; and
a first concave portion for putting a finger formed on an antenna accommodation portion to accommodate the antenna of the first casing.

15. The portable radio device according to claim 14, wherein the curvature of concave portion is the curvature of the cross sectional shape of the finger and over.

16. The portable radio device according to claims 14, further comprising a second concave portion formed on a portion of the opposite side of the first casing of the antenna accommodation portion.

17. A portable radio device comprising:
a first casing in which an antenna and a primary circuit board are accommodated;
a second casing;
a hinge portion to connect together the first and second casings respectively roatatably;
an antenna accommodation portion to accommodate the antenna provided along one side surface of the first casing; and
a battery pack accommodation unit provided between the other side surface of the first casing and the antenna accommodation portion.

18. The portable radio device according to claim 17, further comprising a rib provided along the antenna accommodation portion in the battery pack accommodation unit.

19. A portable radio device comprising:
an antenna portion on the side of a casing;
a circuit board provided in the casing;
a first shield unit provided in the casing; and
a second shield unit provided between the antenna portion and the circuit board,
wherein the first shield unit and the second shield unit shields the electrical noise from the circuit board portion.

20. The portable radio device according to claim 19, wherein the metallic evaporation is conducted on at least one of the first shield portion and the second shield portion.

21. A portable radio device comprising:
an antenna provided on a side of a casing;
an antenna accommodation portion to accommodate the antenna;
a circuit board provided in a casing;
a support plate for supporting the circuit board; and
an auxiliary support plate mounted in the casing so that the support plate is extended to the vicinity of the antenna accommodation portion, the auxiliary support plate partitions a space in which the antenna is accommodated, together with a side portion of the inner surface of the casing, and the circuit board and the antenna are shielded.

22. The portable radio device according to claim 21, wherein the metallic evaporation is conducted on at least one of the support plate and the auxiliary support plate.

23. A folding portable radio device comprising:
a first casing;
a second casing;
a hinge portion to connect together the first and second casings respectively roatatably;
an antenna accommodation portion provided in a side of the first casing to accommodate an antenna;
a circuit board provided in the first casing;
a support plate for supporting the circuit board; and
an auxiliary support plate mounted in the first casing so that the support plate is extended to the vicinity of the antenna accommodation portion, the auxiliary support plate partitions a space in which the antenna is accommodated, together with a side portion of the inner surface of the first casing, and the circuit board and the antenna are shielded.

24. The portable radio device according to claim 23, wherein the metallic evaporation is conducted on at least one of the support plate and the auxiliary support plate.
